(19) United States
(12) Patent Application Publication
(10) Pub. No.: US 2006/0026340 A1
(43) Pub. Date: Feb. 2, 2006

(54) Memory card, card controller mounted on the memory card, and device for processing the memory card

(76) Inventors: Takafumi Ito, Ome-shi (JP); Hiroyuki Sakamoto, Ome-shi (JP); Akihisa Fujimoto, Fussa-shi (JP); Michihito Hatsumi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/003,415

(22) Filed: Dec. 6, 2004

(30) Foreign Application Priority Data
Jul. 27, 2004 (JP) 2004-219179

(51) Int. Cl. G06F 12/00

(52) U.S. Cl. 711/103

(57) ABSTRACT

A card controller mounted on a memory card, includes a first interface which receives a first command from a processing device and a second interface which supplies a data-erasable nonvolatile memory chip with a second command corresponding to the first command received by the first interface. The card controller further includes a control circuit which causes the second interface to output a user data erase command as the second command. The user data erase command is used to erase all user data of data stored in the nonvolatile memory chip.

### CROSS-REFERENCE TO RELATED APPLICATIONS

This application is based upon and claims the benefit of priority from prior Japanese Patent Application No. 2004-219179, filed Jul. 27, 2004, the entire contents of which are incorporated herein by reference.

### BACKGROUND OF THE INVENTION

1. Field of the Invention

The present invention relates to a memory card, a card controller mounted on the memory card, and a device for processing the memory card. More specifically, the invention relates to a method of controlling a memory card using a nonvolatile semiconductor memory such as a flash memory.

2. Description of the Related Art

When a memory card is formatted, only the file management information is often initialized and data in the body of a file (e.g., user data) is left as it is. There is a possibility that the data in the body of the file will be reconstructed because it is not erased. It is thus desirable in terms of security protection that not only the file management information be initialized but also the data in the body of the file be erased.

For example, a block erase command for erasing data from a specified block area is defined in a prior art secure digital (SD) memory card. However, the block erase command is used to designate a range (block area) of erasure within a user data area and erase data for every block area. The designation of the range of erasure is complicated. In particular, data cannot be erased from an alternate memory block area.

Some memory cards or flash memories define a multi-block erase command for erasing data at once from a plurality of block areas by designating each of addresses of the block areas (e.g., U.S. Pat. No. 5,418,752) and a range designation erase command for erasing data at once from a plurality of block areas by designating a plurality of block areas (range of erasure) by the address of the leading block area and the number (size) of block areas (e.g., Jpn. Pat. Appln. KOKAI Publication No. 11-224492).

In both cases described above, however, an operation of a host device becomes complicated to completely erase data from the body of a file. It is thus desired that the operation should be performed with efficiency.

In recent years, there is a flash memory that defines a so-called chip erase command (e.g., Jpn. Pat. Appln. KOKAI Publication No. 5-274215). However, the chip-erase command is not suitable for formatting because only the data in the body of a file cannot be erased.

### BRIEF SUMMARY OF THE INVENTION

According to a first aspect of the present invention, there is provided a card controller mounted on a memory card, comprising a first interface which receives a first command from a processing device; a second interface which supplies a data-erasable nonvolatile memory chip with a second command corresponding to the first command received by the first interface; and a control circuit which causes the second interface to output a user data erase command as the second command, the user data erase command being used to erase all user data of data stored in the nonvolatile memory chip.

According to a second aspect of the present invention, there is provided a memory card comprising a data-erasable nonvolatile memory chip; and a card controller which controls the nonvolatile memory chip, the card controller including a first interface which receives a first command from a processing device; a second interface which supplies the nonvolatile memory chip with a second command corresponding to the first command received by the first interface; and a control circuit which causes the second interface to output a user data erase command as the second command, the user data erase command being used to erase all user data of data stored in the nonvolatile memory chip.

According to a third aspect of the present invention, there is provided a device for processing a memory card including a data-erasable nonvolatile memory chip and a card controller that outputs a user data erase command to erase all user data of data stored in the nonvolatile memory chip, comprising a slot into which the memory card is inserted; and a host controller which issues a first command to supply the user data erase command from the card controller to the memory card inserted into the slot.

According to a fourth aspect of the present invention, there is provided a memory card comprising: a flash memory including a first NAND flash memory chip having a user data area that stores the user data and a nonuser data area that stores data other than the user data and a second NAND flash memory chip having a user data area only; and a card control including a first interface which receives a first command from a processing device and a second interface which supplies the flash memory with a second command corresponding to the first command received by the first interface, the card control causing the second interface to output a chip erase command as the second command in order to erase all of data stored in the flash memory, wherein the chip erase command is supplied to at least the second NAND flash memory chip.

### BRIEF DESCRIPTION OF THE SEVERAL VIEWS OF THE DRAWING

FIG. 1 is a diagram of a digital camera and an SD memory card according to a first embodiment of the present invention.

FIG. 2 is a block diagram showing an example of a configuration of the SD memory card shown in FIG. 1.

FIG. 3 is a diagram showing an example of a configuration of a NAND flash memory of the SD memory card shown in FIG. 2.

FIG. 4 is a diagram showing a basic configuration of the SD memory card shown in FIG. 1.

FIG. 5 is a table showing a relationship between a settable operating mode and pin assignment in the SD memory card shown in FIG. 4.

FIG. 6 is a timing chart illustrating an erase operation according to example 1 of the first embodiment.

FIG. 7 is a timing chart illustrating an erase operation according to example 2 of the first embodiment.

FIG. 8 is a timing chart illustrating an erase operation according to example 3 of the first embodiment.

FIG. 9 is a block diagram showing an example of a configuration of a NAND flash memory according to a second embodiment of the present invention.

FIGS. 10A and 10B are diagrams each showing an example of a configuration of each of memory chips of the NAND flash memory shown in FIG. 9.

FIG. 11 is a timing chart illustrating an erase operation according to the second embodiment of the present invention.

FIG. 12 is a diagram showing a cellular phone and an SD memory card according to a third embodiment of the present invention.

### DETAILED DESCRIPTION OF THE INVENTION

Embodiments of the present invention will now be described with reference to the accompanying drawings.

### First Embodiment

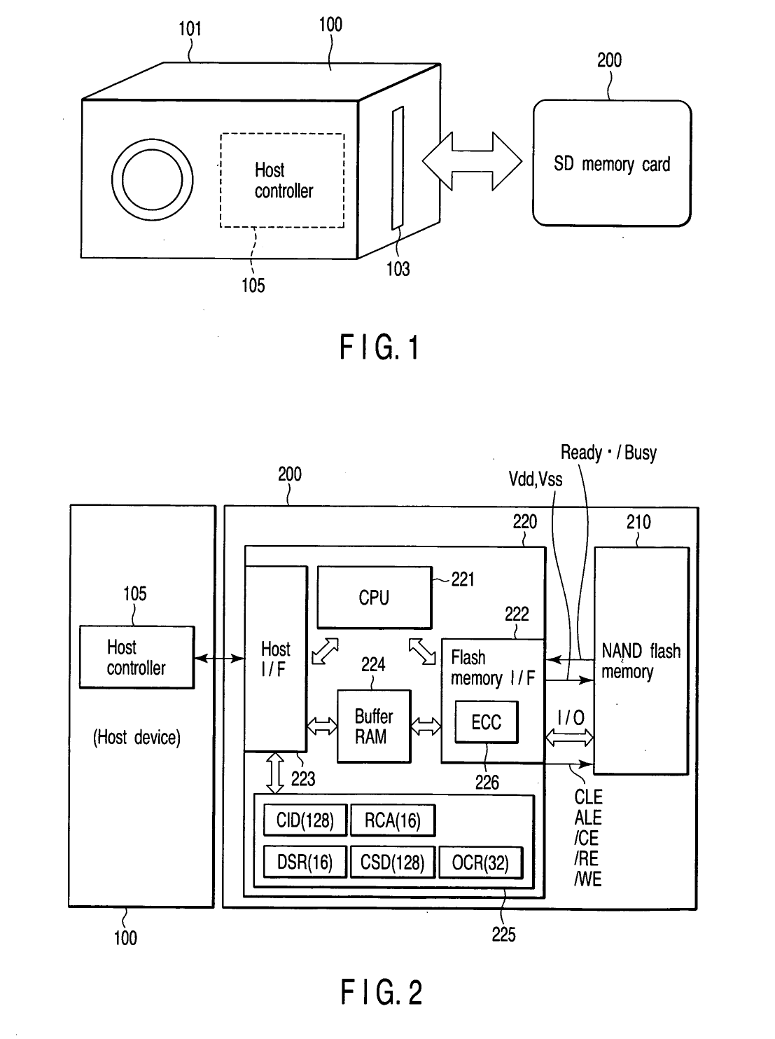

FIG. 1 shows a memory card and its processing device according to a first embodiment of the present invention. In the first embodiment, the memory card is illustrated with an SD memory card 200 and the processing device is illustrated with a digital camera 100.

The digital camera 100 serves as a host device and includes a body 101. The body 101 has a slot 103 into which the SD memory card 200 is inserted. The body 101 also has a host controller 105 therein.

The host controller 105 has a function of gaining access to the inserted SD memory card 200. In other words, the host controller 105 controls write/read of user data (digital images in this embodiment) to/from the SD memory card 200. The host controller 105 issues a first user data erase command (first command) to the SD memory card 200 when the SD memory card 200 is formatted. The first user data erase command is a serial signal for completely erasing all user data as well as initializing file management information when the user data is regarded as data in the body of a file.

The host controller 105 may have a function of picking up and displaying a digital image. This function can be performed by a processor that differs in chip from the host controller 105.

FIG. 2 shows a basic configuration of the SD memory card 200 described above. In this configuration, a flash memory is formed of a single NAND flash memory chip (first NAND flash memory).

The SD memory card 200 is inserted into the slot 103 of the digital camera 100 and supplied with power to operate and perform a process corresponding to access from the host controller 105. The SD memory card 200 has a NAND flash memory 210 and a card controller 220 both mounted on a printed circuit board (PCB).

The NAND flash memory 210 is a nonvolatile semiconductor memory in which normal data erasure is performed in blocks (pages). The NAND flash memory 210 writes and reads data in, e.g., one page. In the first embodiment, the NAND flash memory 210 has a user data erase function of erasing user data (including file management information if the user data is data in the body of a file) completely. The NAND flash memory 210 will be described in detail later.

The card controller 220 is configured to manage the physical state of the NAND flash memory 210. For example, the card controller 220 holds a logic conversion table representing a correspondence between logic and physical block addresses and a table representing if the physical blocks are assigned to the existing logic blocks. The card controller 220 includes a central processing unit (CPU) 221, a flash memory interface (I/F) 222 serving as a second interface, a host interface (I/F) 223 serving as a first interface, a buffer random access memory (RAM) 224, and a static RAM (SRAM) 225 serving as a register.

The flash memory interface 222 performs an interfacing operation between the card controller 220 and the NAND flash memory 210. The flash memory interface 222 and NAND flash memory 210 are connected to each other through signal lines of various signals (e.g., power supply Vdd, ground Vss, I/O, Ready•/Busy, command latch enable CLE, address latch enable ALE, chip enable /CE, read enable /RE, and write enable /WE) Each of the signals with a slash mark on its head is a low-active signal. The chip enable /CE enables the NAND flash memory 210 when its level is low.

The flash memory interface 222 includes an error checking & correction code (ECC) circuit 226.

The host interface 223 performs an interfacing operation between the card controller 220 and the host controller 105. The host interface 223 inputs or outputs various signals of signal lines (e.g., power supply Vdd, ground Vss, data, card sensing, clock, and command) through a plurality of signal pins described later.

The buffer RAM 224 temporarily stores a fixed amount of data (e.g., data of eight pages) when it writes data sent from the host controller 105 in the NAND flash memory 210 and when it supplies the host controller 105 with the data read out of the NAND flash memory 210. The buffer RAM 224 can also be used as a working area of the CPU 221.

The CPU 221 controls the entire operation of the SD memory card 200. When the SD memory card 200 is supplied with power, the CPU 221 loads the firmware (programs for controlling the CPU) stored in the NAND flash memory 210 onto the SRAM 225 and performs a given process to thereby create various tables on the buffer RAM 224. The CPU 221 receives a write command, a read command or a normal erase command from the host controller 105 and performs a given process for the NAND flash memory 210. The CPU 221 also controls a process of transferring data through the buffer RAM 224.

The CPU 221 does not load the whole (or part) of firmware onto the SRAM 225 from the NAND flash memory 210 but stores it in a read only memory (ROM, not shown) provided in the controller 220. Thus, the CPU 221 can execute the control programs stored in the ROM.

Upon receiving a first user data erase command from the host controller 105, the CPU 221 generates a second user data erase command (second command) and outputs it to the NAND flash memory 210 through the flash memory interface 222. The second user data erase command makes it possible to erase all user data stored in the NAND flash memory 210 and including file management information when the user data is data in the body of a file.

The SRAM 225 is a memory for storing the control programs to be controlled by the CPU 221, the initial value and the like.

The ECC circuit 226 corrects an error of data to be written to the NAND flash memory 210 and that of data read therefrom.

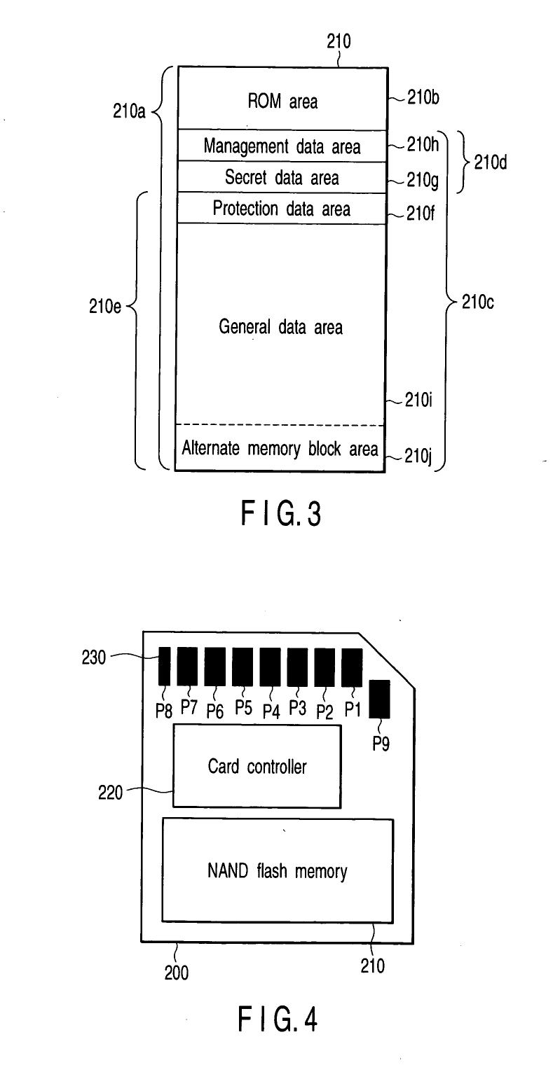

FIG. 3 shows a configuration of the NAND flash memory 210 described above. A memory cell array (memory area) 210a of the NAND flash memory 210 is generally divided into a ROM area 210b and a normal area 210c. The ROM area 210b is an area that is not available by a user or the card controller 220 (nonuser data area) but used for storing information necessary for controlling the NAND flash memory 210 (e.g., information on high-voltage trimming for programming and erasing data, address information for redundancy processing, and control programs of the NAND flash memory in itself). The normal area 210c is memory space that is available by a user and the card controller 220.

The normal area 210c is divided into a control information storage area (nonuser data area) 210d and user data area 210e. The control information storage area 210d includes a secret data area 210g and a management data area 210h. The secret data area 210g stores secret data, such as key information for encryption and secret data unique to a card used for authentication (e.g., security information and media ID of the SD memory card 200). The management data area 210h chiefly stores management information on the SD memory card 200, such as firmware, initial value data for controlling the firmware, initial value data of the register, and positional information of each area of the NAND flash memory 210 (or part of the data and information).

The user data area 210e stores user data (including file management information when a digital image is data in the body of a file) which is freely accessible and available by a user of the SD memory card 200. For example, the user data area 210e includes a protection data area 210f, a general data area 210i and an alternate memory block area 210j. The protection data area 210f stores significant data and can be accessed only when the digital camera 100 is authenticated by two-way authentication with the SD memory card 200 that is inserted into the digital camera 100. The alternate memory block area 210j is used to replace defective cells in the general data area 210i in blocks. The alternate memory block area 210j is also used as a spare block with a function of temporarily saving data to be written back. This function is unique to a flash memory.

The NAND flash memory 210 writes and reads data in, e.g., one page (e.g., 2112 bytes or 512 bytes). Further, it normally erases data in blocks including a plurality of pages (e.g., 128 kilobytes or 16 kilobytes). In formatting, for example, it can erase data of all block areas of the user data area 210e, or all user data (a so-called user data erase function).

The NAND flash memory 210 has a wiring width of about 90 nanometers (nm). It may have a wiring width of smaller than 70 nm. In the NAND flash memory 210, one chip may have a capacity of 2 gigabits. For example, copper (Cu) can be used as the materials of wiring.

The NAND flash memory 210 included in the SD memory card 200 is controlled by, for example, an FAT file system.

The NAND flash memory 210 may serve as a binary memory for storing data of one bit in one memory cell and a multilevel memory for storing data of two or more bits in one memory cell. The NAND flash memory 210 and card controller 220 can be mounted on the same large-scale integrated (LSI) substrate.

FIG. 4 shows a basic configuration of the SD memory card 200 described above. The SD memory card 200 includes a plurality of signal pins 230 (nine pins P1 to P9 in this embodiment) to contact (communicate with) the host controller 105. The pins P1 to P9 are electrically connected to the card controller 220 via the host interface 223.

As one example, the pin P1 is assigned for a data signal (DAT3) and a card detection signal (CD). The pins P2, P4 and P5 are assigned for a command (CMD), a power supply Vdd and a clock signal (CLK), respectively. The pins P3 and P6 are assigned for a ground Vss. The pins P7, P8 and P9 are assigned for their respective data signals (DAT0, 1, 2).

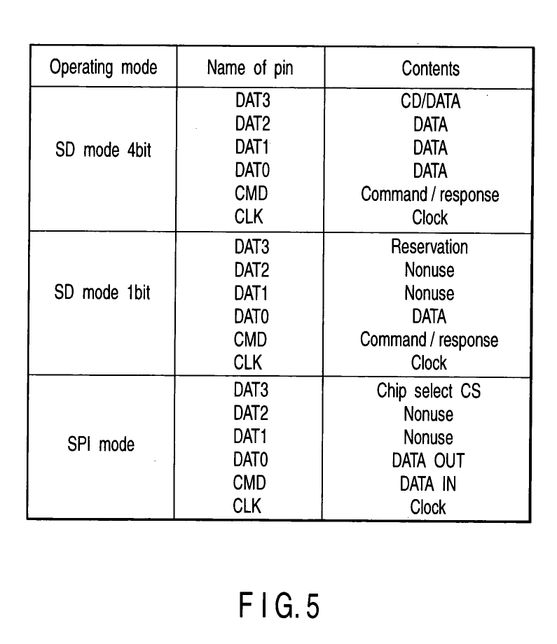

FIG. 5 shows a relationship between a settable operating mode and pin assignment in the SD memory card 200 described above. In the first embodiment, the SD memory card 200 has three operating modes, i.e., an SD mode (4-bit), an SD mode (1-bit) and an SPI mode. In other words, the operating mode of the SD memory card 200 is broadly divided into an SD mode and an SPI mode. In the SD mode, the SD memory card 200 is set in one of the SD mode (4-bit) and SD mode (1-bit) in response to a bus width change command from the host controller 105 of the digital camera 100.

Paying attention to four pins P1 (DAT3), P7 (DAT0), P8(DAT1) and P9(DAT2) for data signals, all of these pins are used for data transfer in the SD mode (4-bit) in which data is transferred in 4-bit widths. On the other hand, in the SD mode (1-bit) in which data is transferred in 1-bit widths, only the pin P7 is used for data transfer. Neither of pins P8 and P9 is used at all. The pin P1 is used for an asynchronous interrupt in the host controller 105 from the SD memory card 200.

In the SPI mode, the pin P7 is used as a data signal line (DATA OUT) from the SD memory card 200 to the host controller 105. The pin P2 is used as a data signal line (DATA IN) from the host controller 105 to the SD memory card 200. Neither of the pins P8 and P9 is used at all. Further, the pin P1 is used to transmit a chip select signal (CS) from the host controller 105 to the SD memory card 200

In the foregoing configuration, the SD memory card 200 is inserted into the slot 103 of the digital camera 100 to communicate with the host controller 105 via the signal pins 230. When data is written to the NAND flash memory 210 of the SD memory card 200, the card controller 220 receives a write command, which is to be supplied to the pin P2, as a serial signal in synchronization with a clock signal supplied to the pin from the host controller 105. In other words, the host controller 105 serially supplies commands to the card controller 220 through only the pin P2.

Further descriptions will be given about communications between the NAND flash memory 210 and card controller 220. The card controller 220 communicates with the NAND flash memory 210 via, e.g., I/O lines I/O1 to I/O8 of eight bits. When data is written to the NAND flash memory 210, the card controller 220 sequentially supplies a data input command (80H), a column address, a page address, data and a program command (10H) from the flash memory interface 222 to the NAND flash memory 210 through the I/O lines IO1 to IO8.

The alphabet “H” of the above command (80H) represents a hexadecimal number. In actuality, an 8-bit signal of “10000000” is supplied to the I/O lines I/O1 to I/O8. In other words, the flash memory interface 222 outputs commands defined by a plurality of bits in parallel. The I/O line that connects the flash memory interface 222 and NAND flash memory 210 is common to commands and data.

As described above, the interface (host interface 223) that communicates between the host controller 105 of the digital camera 100 and the SD memory card 200 and the interface (flash memory interface 222) that communicates between the NAND flash memory 210 and the card controller 220 differ from each other in communication scheme.

The following are descriptions of the user data erase function in the above configuration, or some methods of completely erasing all user data stored in the NAND flash memory 210 of the SD memory card 200 inserted into the digital camera 100.

### EXAMPLE 1

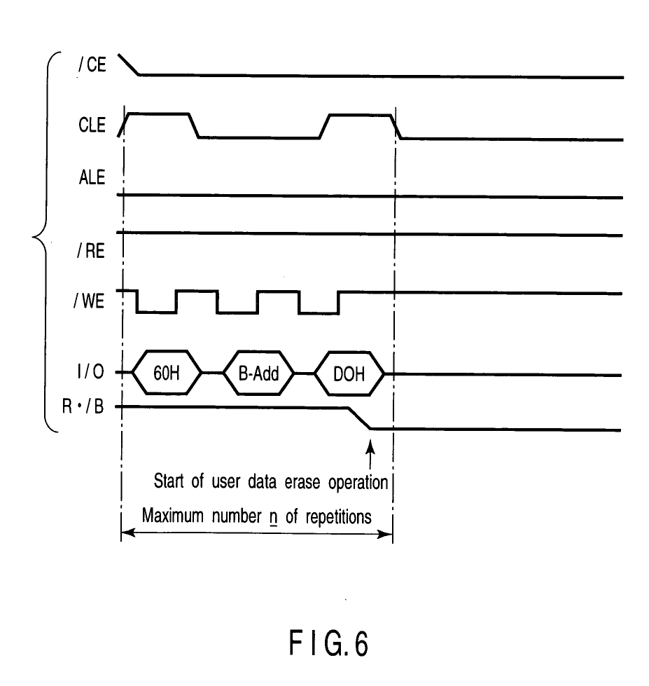

FIG. 6 shows a method of erasing all user data from the user data area 210e repeatedly in units of blocks.

Assume that the host controller 105 of the digital camera 100 outputs a first user data erase command when the SD memory card is formatted. The first user data erase command is serially input to the SD memory card 200 through the signal pins 230. Then, the card controller 220 of the SD memory card 200 receives the first user data erase command through the host interface 223. The CPU 221 generates a second user data erase command. The generated second user data erase command includes commands which are output in parallel from the flash memory interface 222 to the NAND flash memory 210 through the 8-bit I/O lines.

In example 1, the CPU 221 obtains an address of each of block areas that store user data, based on the positional information of each area of the NAND flash memory 210, which is stored in the management data area 210h. In order to erase data repeatedly from each block area specified by the address, the CPU 221 generates the second user data erase command automatically for each block area. The commands of the second user data erase command are, for example, an address input command (60H), a block address (B-Add) and an erase command (D0H) shown in FIG. 6. In other words, in example 1, the second user data erase command is generated repeatedly in accordance with the number of block areas that store user data (the maximum number is the number (n) of all blocks in the user data area 210e). If user data is erased in sequence from a user data area of 1024 blocks using a NAND flash memory whose erase block size is 16 kilobytes, it corresponds to 1.6 gigabytes.

The NAND flash memory 210 to which the second user erase command is input, erases all user data (including the above file management information) from the user data area 210e repeatedly in units of blocks. More specifically, the NAND flash memory 210 latches the commands on the I/O line in response to an edge at which write enable /WE rises from “L” to “H” when command latch enable CLE is high (H), address latch enable ALE is low (L), chip enable /CE(0) is low, and read enable /RE is high as shown in FIG. 6. Upon receiving an erase command (D0H), the NAND flash memory 210 starts a user data erase operation to erase data from a block area corresponding to the erase command and makes Ready•/Busy (R•/B) low (L). The above erase operation is repeated until all user data is erased from the user data area 210e. Thus, not only the file management information can be erased (initialized), but also the user data can easily be erased when the SD memory card 200 is formatted.

As described above, a simple operation of the digital camera 100 allows user data to be erased from the user data area 210e repeatedly in units of blocks. In other words, a second user data erase command for enabling all user data to be easily erased can automatically be generated in accordance with a first user data erase command from the digital camera 100. It is thus possible to easily erase all user data from the user data area 210e including the alternate memory block area 210j without performing any complicated operation. Consequently, user data can be protected from leakage even though the third party tries to reconstruct the user data after the SD memory card 200 is formatted. That is, secret data can easily be ensured.

An identification flag indicating whether a block is defective or not is written in advance to a given redundant section in each of block areas (e.g., a redundancy bit of the first page). If the flag indicates that a block area is defective, data in the defective block area is inhibited from being erased in the test step, and the flag can be left. It is thus possible to obtain the advantage that no flag needs to be rewritten after the erase operation is performed.

### EXAMPLE 2

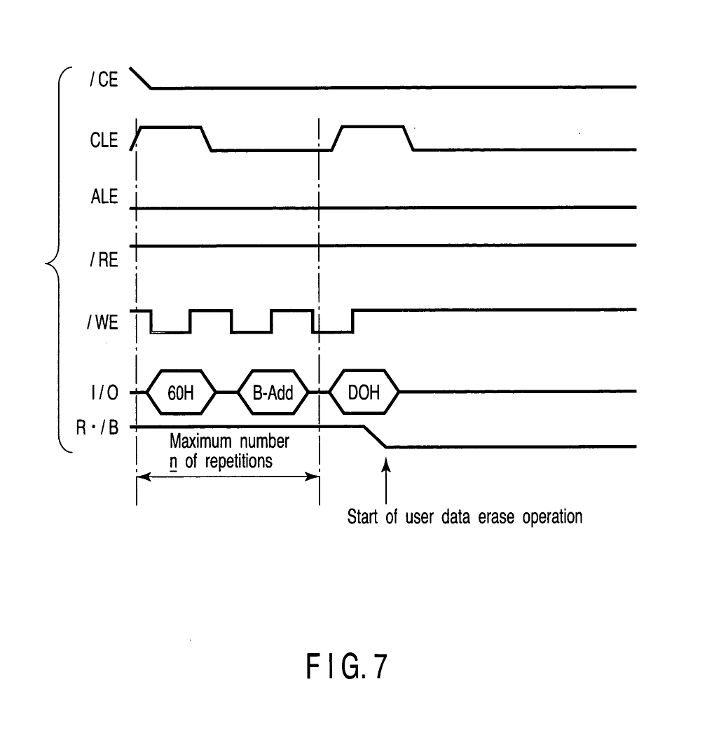

FIG. 7 shows a method of erasing all user data from the user data area 210e at once (at the same time). In example 2, a range in which an erase operation is performed is repeatedly specified in units of blocks.

Assume that the host controller 105 of the digital camera 100 outputs a first user data erase command when the SD memory card is formatted. The card controller 220 of the SD memory card 200 serially receives the first user data erase command through the signal pins 230 and host interface 223. Then, the CPU 221 generates a second user data erase command.

In example 2, the CPU 221 obtains an address of each of block areas that store user data, based on the positional information of each area of the NAND flash memory 210, which is stored in the management data area 210h. In order to erase data simultaneously from each block area specified by the address, the CPU 221 generates the second user data erase command, e.g., commands including an address input command (60H) and a block address (B-Add) shown in FIG. 7 repeatedly for each block area, and finally automatically generates the second user data erase command to which an erase command (D0H) is added. In other words, in example 2, the commands of the address input command (60H) and block address (B-Add) are generated repeatedly in accordance with the number of block areas that store user data (the maximum number is the number (n) of all blocks in the user data area 210e).

The second user data erase command generated by the CPU 221 includes commands which are output in parallel from the flash memory interface 222 to the NAND flash memory 210 through the 8-bit I/O lines. Thus, the NAND flash memory 210 erases all user data (including the above file management information) simultaneously from the user data area 210e. More specifically, the NAND flash memory 210 latches the commands on the I/O line in response to an edge at which write enable /WE rises from “L” to “H” when command latch enable CLE is high (H), address latch enable ALE is low (L), chip enable /CE(0) is low, and read enable /RE is high as shown in FIG. 7. The above operation is repeated until the NAND flash memory 210 latches all the commands on the I/O line. Upon receiving an erase command (D0H), the NAND flash memory 210 starts a user data erase operation to erase data simultaneously from a block area corresponding to the erase command and makes Ready•/Busy (R•/B) low (L).

In example 2, too, not only the file management information can be erased (initialized), but also user data can easily be erased when the SD memory card 200 is formatted, as in example 1 described above.

Of user data, only the file management information is not erased but left, or ineffective data in a defective block area is not erased in advance to erase effective data only. Thus, a versatile, efficient erase operation can easily be carried out.

### EXAMPLE 3

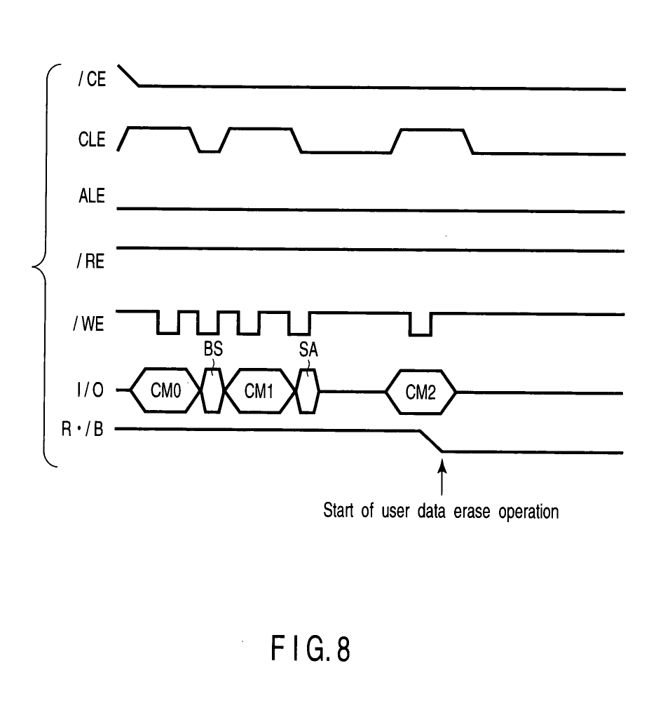

FIG. 8 shows another method of erasing all user data from the user data area 210e at once. In example 3, the number of block areas (block size) is used to specify a range in which an erase operation is performed.

Assume that the host controller 105 of the digital camera 100 outputs a first user data erase command when the SD memory card is formatted. The card controller 220 of the SD memory card 200 serially receives the first user data erase command through the signal pins 230 and host interface 223. Then, the CPU 221 generates a second user data erase command.

In example 3, the CPU 221 obtains an address of the leading block area (start address SA) and the number of block areas from the leading block area to the trailing block area (block size BS), based on the positional information of each area of the NAND flash memory 210, which is stored in the management data area 210h. In order to erase data at once from block areas in the ranges specified continuously by the start address SA and block size BS, the CPU 221 automatically generates the second user data erase command including a size input command (CM0), a block size (BS), an address input command (CM1), a start address (SA), and a specified range erase command (CM2) shown in FIG. 8 repeatedly for each block area.

The above commands of the second user data erase command generated by the CPU 221 are output in parallel from the flash memory interface 222 to the NAND flash memory 210 through the 8-bit I/O lines. The NAND flash memory 210 latches the commands on the I/O line in response to an edge at which write enable /WE rises from “L” to “H” when command latch enable CLE is high (H), address latch enable ALE is low (L), chip enable /CE(0) is low, and read enable /RE is high as shown in FIG. 8. Upon receiving the specified range erase command (CM2), the NAND flash memory 210 starts a user data erase operation to erase data simultaneously from all block areas within the specified range and makes Ready•/Busy (R•/B) low (L)

In example 3, too, not only the file management information can be erased (initialized), but also user data can easily be erased when the SD memory card 200 is formatted, as in examples 1 and 2 described above.

Another method of example 3 can be applied when a range for performing an erase operation can be specified by an address (end address) of the last block area that stores user data in place of the block size (BS).

The foregoing examples 1 to 3 are applied to a single NAND flash memory 210 to erase user data from the user data area 210e. However, the flash memory can be formed of a plurality of NAND flash memory chips.

The foregoing examples 1 to 3 are also applied to erasure of only user data in the user data area 210e. In some cases, however, they can be applied to erasure (or selective erasure) of all data not only in the user data area 210e but also in the normal area 210c which includes the control information storage area 210d and can be accessed by the card controller 220 only.

Moreover, a specific command can automatically be generated without specifying a range of erasure by the address or size of a block area to perform an erase operation by setting all block areas of the user data area 210e as the range of erasure.

It is needless to say that user data can be erased when the need arises as well as when the memory card is formatted.

### Second Embodiment

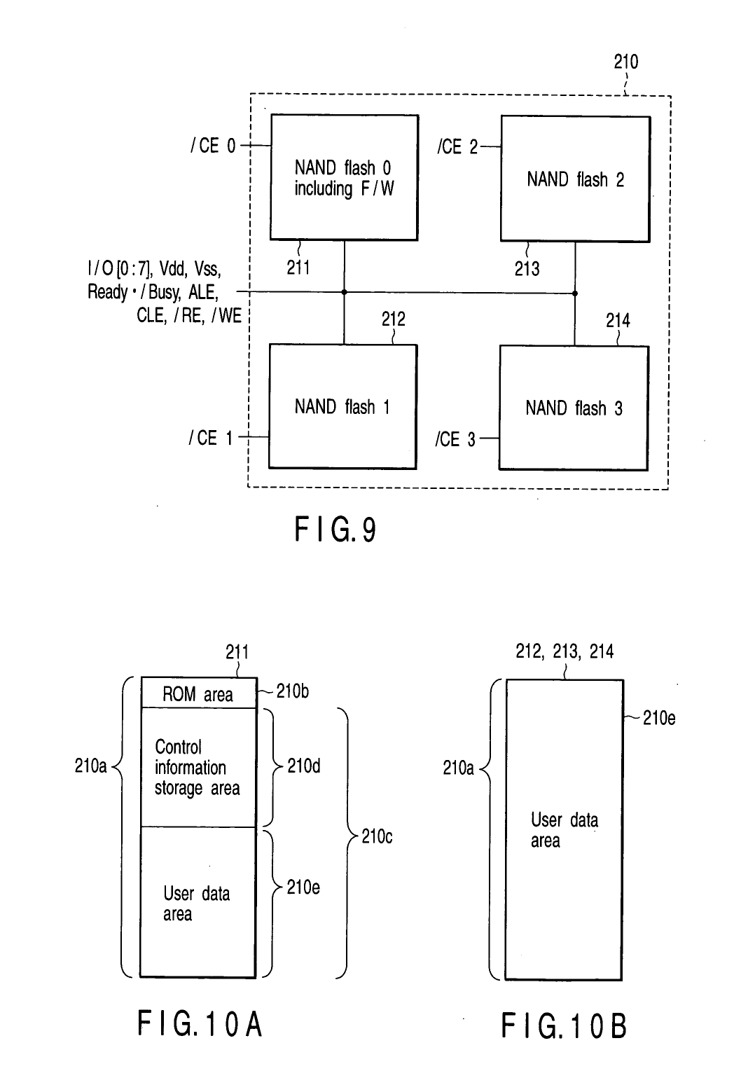

FIG. 9 shows an example of a configuration of a NAND flash memory according to a second embodiment of the present invention. The second embodiment is directed to a flash memory as shown in FIG. 2 which is configured by a plurality of NAND flash memory chips (four NAND flash memory chips in FIG. 9). The chip erase function of the NAND flash memory (disclosed in, e.g., Jpn. Pat. Appln. KOKAI Publication No. 5-274215) is used to erase user data.

The NAND flash memory 210 includes four NAND flash memory chips 211 to 214 (NAND flashes 0 to 3). The chips 211 to 214 are supplied with their respective chip enables /CE0 to /CE3. In contrast, signal lines of power supply Vdd, ground Vss, I/O, Ready•/Busy, command latch enable CLE, address latch enable ALE, read enable /RE, and write enable /WE are shared by the four NAND flash memory chips 211 to 214. In FIG. 9, these signal lines are represented as one signal line for the sake of convenience.

The NAND flash memory chip (first NAND flash memory chip) 211 includes a memory area 210a as shown in FIG. 10A. The memory area 210a is divided into a ROM area 210b and a normal area 210c. The normal area 210c has a control information storage area (nonuser data area) 210d and a user data area 210e. On the other hand, the NAND flash memory chips (second NAND flash memory chips) 212 to 214 each include a memory area 210a the whole of which is assigned as a user data area 210e, as shown in FIG. 10B. The user data area 210e corresponds to the normal area 210c.

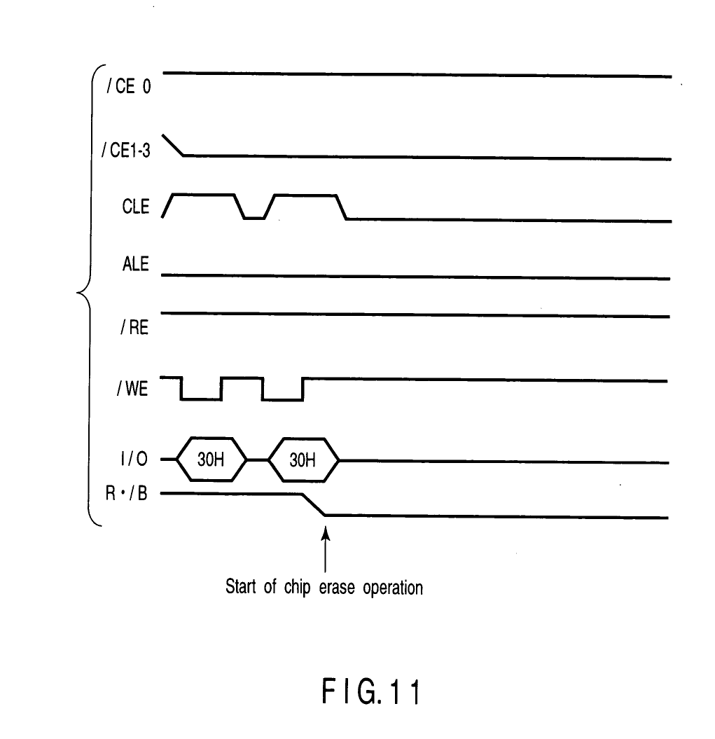

FIG. 11 shows a method of erasing user data at once from the NAND flash memory 210 in the second embodiment. The chip erase function is to erase all data from the normal area 210c, which is available by the card controller 220, in response to a chip erase command from the card controller 220.

Assume that the host controller 105 of the digital camera 100 outputs a first user data erase command when the SD memory card is formatted. The card controller 220 of the SD memory card 200 serially receives the first user data erase command through the signal pins 230 and host interface 223. Then, the CPU 221 generates chip erase commands.

The CPU 221 automatically generates chip erase commands for erasing all data at once from the normal area 210c of the NAND flash memory chip 211 and the user data areas 210e of the NAND flash memory chips 212 to 214, e.g., chip erase commands (30H-30H) including repetitive commands (30H) as shown in FIG. 11. The chip erase commands (30H-30H) are supplied in parallel to the NAND flash memory chips 212 to 214 from the flash memory interface 222 through the 8-bit I/O line.

The NAND flash memory chips 212 to 214 latches the commands (30H) on the I/O line in response to an edge at which write enable /WE rises from “L” to “H” when command latch enable CLE is high (H), address latch enable ALE is low (L), chip enables /CE1 to /CE3 are low, and read enable /RE is high as shown in FIG. 11. Upon receiving the second command (30H), the NAND flash memory chips 212 to 214 starts a chip erase operation to erase user data simultaneously from all block areas of the user data area 210e corresponding to the normal area 210c and makes Ready•/Busy (R•/B) low (L).

On the other hand, in the NAND flash memory chip 211, the chip enable /CE0 is high as shown in FIG. 11. Thus, the NAND flash memory chip 211 does not receive the chip erase commands (30H-30H). In other words, the chip enable /CE0 corresponding to the NAND flash memory chip 211 remains high (H) to inhibit the NAND flash memory chip 211 from receiving the chip erase commands (30H-30H). Consequently, a chip erase operation is carried out only in the NAND flash memory chips 212 to 214.

According to the second embodiment, only the user data (including file management information), which is stored in the user data area 210e of each of the NAND flash memory chips 212 to 214, can easily be erased without losing secret data (in secret data area 210g) or card information (in management data area 210h) which is stored in the control information storage area 210d of the NAND flash memory chip 211 when the SD memory card 200 is formatted.

Since, however, the user data stored is not erased but left in the user data area 210e of the NAND flash memory chip 211, significant user data is stored in the NAND flash memory chips 212 to 214. The problem of security can be resolved accordingly.

As described above, the chip erase commands are supplied to only the NAND flash memory chips 212 to 214 that store only user data, excluding the NAND flash memory chip 211 that stores firmware. Only the user data can thus be erased, leaving data necessary for controlling the CPU 221, such as firmware, as it is. If the chip erase function is fulfilled, a simple operation of the digital camera 100 enables user data to be easily erased in the NAND flash memory chips 212 to 214.

In order to erase all user data including necessary data such as firmware from the NAND flash memory chips 211 to 214, when chip erase commands are output, their corresponding chip enables /CE to /CE3 all have only to be set low.

The chip enable commands can be supplied to the four NAND flash memory chips 211 to 214 at the same time and in sequence. Further, they can easily be applied thereto selectively.

Since the NAND flash memory chip 211 stores firmware and the like and the NAND flash memory chips 212 to 214 store user data only, a chip erase command can be supplied to the NAND flash memory chips 212 to 214, while the second user data erase command shown in the foregoing examples 1 to 3 can be supplied to the NAND flash memory chip 211. In this case, all the user data stored in the NAND flash memory chips 211 to 214 can be erased completely and efficiently.

In the second embodiment, too, not only file management information can be erased (initialized), but also user data can easily be erased when the SD memory card 200 is formatted as in the first embodiment described above.

It is needless to say that user data can be erased when the need arises as well as when the memory card is formatted.

### Third Embodiment

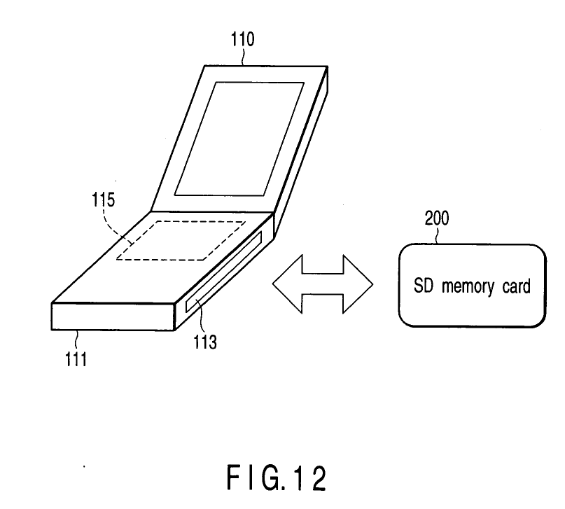

The host device (processing device) using the SD memory card 200 is not limited to the foregoing digital camera. For example, it can be applied to a cellular phone 110 with a camera as shown in FIG. 12.

The cellular phone 110 includes a body 111 having a slot 113 into which an SD memory card 200 is inserted. The body 111 includes a host controller 115. The host controller 115 has a function of gaining access to the SD memory card 200 to control the write/read of user data (personal information such as digital images and telephone numbers) to/from the SD memory card 200. When the SD memory card 200 is formatted, the host controller 115 issues a first user data erase command (first command) to the SD memory card 200.

In contrast, the SD memory card 200 automatically generates a second user data erase command or a chip erase command to erase at least effective user data as in the first and second embodiments.

In the cellular phone 110 using the SD memory card 200, user data can easily be erased from the SD memory card 200 by a simple operation of the cellular phone 110 performed directly by a user, as in the first and second embodiments. Thus, user data such as personal information can be prevented from leaking, thereby facilitating security protection.

In the cellular phone 110, a user can erase user data by, e.g., remote control using a communication function without performing a user's direct operation of the cellular phone 110. If the user loses the cellular phone 110 into which the SD memory card 200 is inserted, the cellular phone 110 receives a specific signal from a common carrier that the user informed and the host controller 115 issue a first user data erase command to the SD memory card 200.

As described above, it is needless to say that user data can be erased when the need arises as well as when the SD memory card is formatted.

The host device (processing device) is not limited to a digital camera or a cellular phone. For example, it can be applied to a personal computer (PC) and a card reader/writer.

In the foregoing embodiments, data of an unsecured common data area and that of a secure protection data area are erased at once in order to erase data of the user data area with efficiency. As another embodiment, when data is erased from a secure area, a first user data erase command can be received from a host device that is accessible to the secure area, based on attribute information (CSD) and the like. It is thus possible to prevent the host device that is originally inaccessible to a secure area from erasing data of the secure area. In this case, a command for erasing data from the common data area and that for erasing data from the protection data area can be caused to differ from each other.

One method of preventing user data from leaking from a card is to erase as much user data as possible in response to a single command from the host device. All user data is not erased from the card in response to the single command from the host device, but user data of not less than fifty erase blocks of the NAND flash memory can be erased from the card. In order to prevent user data from being erroneously erased at once, the host controller can repeatedly send out a first user data erase command to the card at least two or more times.

In the foregoing embodiments, a user can be informed of time required for erasing user data. The user data erasing time generally varies with the characteristics of the NAND flash memory 210 to be used, the size of the user data area 210e, a data erasing method adopted by the card controller 220, and the like. If, therefore, estimated time is stored in advance in the NAND flash memory 210 as attribute information (CSD), the user can easily be informed of the user data erasing time.

The present invention is not limited to the SD memory card.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A card controller mounted on a memory card, comprising:
a first interface which receives a first command from a processing device;
a second interface which supplies a data-erasable nonvolatile memory chip with a second command corresponding to the first command received by the first interface; and
a control circuit which causes the second interface to output a user data erase command as the second command, the user data erase command being used to erase all user data of data stored in the nonvolatile memory chip.

2. The card controller according to claim 1, wherein the first interface receives commands of the first command serially, and the second interface outputs commands of the second command in parallel.

3. The card controller according to claim 1, wherein the user data erase command is used to erase at least effective user data repeatedly in blocks from a user data area that stores the user data.

4. The card controller according to claim 1, wherein the user data erase command is used to erase at least effective user data at once from a user data area that stores the user data.

5. A memory card comprising:
a data-erasable nonvolatile memory chip; and
a card controller which controls the nonvolatile memory chip, the card controller including:
a first interface which receives a first command from a processing device;
a second interface which supplies the nonvolatile memory chip with a second command corresponding to the first command received by the first interface; and
a control circuit which causes the second interface to output a user data erase command as the second command, the user data erase command being used to erase all user data of data stored in the nonvolatile memory chip.

6. The memory card according to claim 5, wherein the nonvolatile memory chip is a single NAND flash memory having a user data area that stores the user data and a nonuser data area that stores data other than the user data.

7. The memory card according to claim 5, wherein the nonvolatile memory chip includes a first NAND flash memory having a user data area that stores the user data and a nonuser data area that stores data other than the user data and a second NAND flash memory having a user data area only.

8. The memory card according to claim 5, wherein the nonvolatile memory chip is a NAND flash memory that allows the user data to be erased in blocks, and the user data erase command is used to erase at least effective user data repeatedly in blocks from a user data area that stores the user data.

9. The memory card according to claim 5, wherein the nonvolatile memory chip is a NAND flash memory that allows the user data to be erased in blocks, and the user data erase command is used to erase at least effective user data at once from a user data area that stores the user data in according with specified blocks.

10. The memory card according to claim 5, wherein the nonvolatile memory chip is a NAND flash memory that allows the user data to be erased in blocks, and the user data erase command is used to erase all user data at once from a user data area that stores the user data in accordance with a specified range.

11. The memory card according to claim 5, wherein the nonvolatile memory chip is a NAND flash memory that allows the user data to be erased in blocks, and the user data erase command is used to erase all user data at once from a user data area that stores the user data.

12. A device for processing a memory card including a data-erasable nonvolatile memory chip and a card controller that outputs a user data erase command to erase all user data of data stored in the nonvolatile memory chip, comprising:
a slot into which the memory card is inserted; and
a host controller which issues a first command to supply the user data erase command from the card controller to the memory card inserted into the slot.

13. A memory card comprising:
a flash memory including a first NAND flash memory chip having a user data area that stores the user data and a nonuser data area that stores data other than the user data and a second NAND flash memory chip having a user data area only; and
a card control including a first interface which receives a first command from a processing device and a second interface which supplies the flash memory with a second command corresponding to the first command received by the first interface, the card control causing the second interface to output a chip erase command as the second command in order to erase all of data stored in the flash memory,
wherein the chip erase command is supplied to at least the second NAND flash memory chip.

14. The memory card according to claim 13, wherein the first interface receives commands of the first command serially, and the second interface outputs commands of the second command in parallel.

15. The memory card according to claim 13, wherein the card controller causes the second interface to supply at least the first NAND flash memory chip with a user data erase command as the second command, the user data erase command being used to erase the user data only.
